(19) United States
(12) Patent Application Publication
(10) Pub. No.: US 2013/0020383 A1
(43) Pub. Date: Jan. 24, 2013

(54) Box and Method for Manufacturing a Box

(71) Applicants: Frank Tautz, Rahden (DE); Klaus Gerke, Bassum (DE)

(72) Inventors: Frank Tautz, Rahden (DE); Klaus Gerke, Bassum (DE)

(21) Appl. No.: 13/549,824

(22) Filed: Jul. 16, 2012

(30) Foreign Application Priority Data
Jul. 22, 2011 (DE) 10 2011 108 355 7

(51) Int. Cl. B65D 5/32; B31B 1/62

(52) U.S. Cl. 229/122.24; 493/110

(57) ABSTRACT

The box (17, 21, 31, 41, 51) is created on the basis of a multi-element lined box part (1), to which two separate and likewise lined sidewalls (13, 14) are glued. The multi-element box part (1) comprises a bottom (10), as well as the two other sidewalls (11, 12). The two separate third and fourth sidewalls (13, 14) are glued on by means of straps (4.1, 4.2) flush with or slightly set back to the edges of the multi-element box part (1), wherein the multi-element box part (1) is quasi folded around the third and fourth sidewalls (13, 14). This results in a rigid box (17, 21, 31, 41, 51) that in its simplest form consists of an upwardly open case.

### BACKGROUND

The present invention pertains to a method for manufacturing a box, as well as a box construction.

Rigid boxes consisting of sheet-lined cardboard are used as high-quality sales and gift packages and also referred to as fine cardboard boxes or luxury cardboard boxes. Typical examples are slip-top boxes with two cases that are closed on five sides and therefore open on one side. One individual case is also used as a book slipcase. There also exist hinged cover boxes, in which the case that is closed on five sides is connected to a multi-element cover construction.

The manufacture of such boxes is elaborate, not very flexible and relatively expensive due to the partially double material usage.

During the manufacture, relatively complicated cardboard blanks and cover material blanks are initially punched out with individually fabricated punching tools. The four sidewalls of the cardboard blank that are still connected to the bottom by means of parting lines that are not punched through are then positioned upright in a box covering machine with a punch that is individually adapted to the case format and presses the bottom into an uprighting shaft such that the sidewalls can be fixed by means of paper strips glued over the corners or beads of glue injected into the joints. The thusly formed cardboard case is then placed onto the cover material blank that is provided with glue over its entire surface and the cardboard case and the cover material blank are jointly pressed into a press-on shaft, wherein two opposing lateral surfaces of the cover material are initially pressed on and folded around the case edges and the two other lateral surfaces are subsequently pressed on. After the upper section of the double punch has been lifted out of the case, the upwardly protruding cover material is folded inward and placed against the inner side of the cardboard case and pressed on by the punch that now once again moves downward.

The multi-element cover construction for a hinged cover box is composed of several cardboards that are arranged parallel and jointly lined over their entire surface and with turn-ins on all sides. It features a bottom, onto which the covered case subsequently is glued manually. The actual cover is connected to the bottom by means of an additional sidewall and usually lined with another cover material. The hinged cover box according to the state of the art therefore features a double bottom and at least one double sidewall.

A cardboard lining and turn-in machine such as, e.g., a casemaker, is required for the manufacture of the multi-element cover constructions. In addition to a punching machine, a special box coating machine is required for the manufacture of the case. The assembly of the case and the cover construction then still takes place manually.

The conversion to a different box format requires a significant effort. It is not only necessary to prepare the punching tools for the cardboard and the cover material, but also the punches and additional press-on means that are individually adapted to the format. During the set-up phase of the box coating machine, corrections of the punches are frequently required such that the conversion and set-up may drag on for several hours. An economical manufacture of boxes therefore can only be realized for larger batches.

### SUMMARY

The present invention is directed to a method for manufacturing a box that also makes it possible to economically and flexibly manufacture high-quality boxes in smaller batches. A related aim is to provide a box construction, in which the material usage is minimized, wherein this box construction can be manufactured in a purely mechanical fashion by utilizing few machines.

According to a method embodiment, the box is created on the basis of a multi-element lined box part, to which two separate and likewise lined sidewalls are glued. The multi-element box part comprises the bottom, as well as two of the four sidewalls. The two other sidewalls are glued on by means of straps flush with or slightly set back to the edges of the multi-element box part, wherein the multi-element box part is quasi folded around the third and fourth sidewalls. This results in a rigid box that in its simplest form defines an upwardly open case.

Simple cardboard and cover material blanks that can be produced with conventional circular cardboard shears and blank cutting machines are processed in this method. Only the corners of the cover blanks still need to be removed. The multi-element box part, as well as the separate third and fourth sidewalls, may be manufactured with a conventional cardboard lining and turn-in machine such as, e.g., a casemaker. During the joining of the multi-element box part to the third and fourth sidewalls, the straps of the third and the fourth sidewalls merely need to be provided with glue and folded by 90° onto the inner sides of the multi-element box part and pressed on.

A machine intended for this purpose can have a much simpler design than known box coating machines and can also be converted to different formats in a simpler fashion. The previous elaborate uprighting of a box is quasi replaced with simply folding the multi-element box part. It is also no longer necessary to fix the case by means of paper strips that are glued over the edges or beads of glue injected into the joints. Furthermore, no cover materials need to be pressed on the case and elaborately folded and turned in such that individually adapted punches are no longer required.

In boxes with wide bottoms between the first and second sidewalls, in particular, the stability of the box can be increased in that an edge of the third and fourth sidewalls that respectively faces the bottom is glued to the bottom at least in certain points. The gluing can be easily realized in that an edge of the cover material protrudes on the edge of the third and fourth sidewalls that faces the bottom in the form of a third strap that is glued onto the inner side of the bottom in the form of an orthogonally folded strap.

The processing of one-piece cardboards simplifies the handling of the cardboards at the cardboard lining and turn-in machine. In addition, only one rather than the otherwise required three or more cardboards need to be cut to size. The grooved folding lines in the one-piece cardboards produce sharp and completely filled out edges between the bottom and the first and second sidewalls that cannot be manufactured in box coating machines during the folding of the multi-element box part.

Hinged cover boxes can be easily realized with additional cardboards arranged in the multi-element box part. The hinged cover box does not feature double bottoms and sidewalls. Depending on the arrangement of the additionally provided cardboards, various hinged cover box constructions from a simple one-piece cover to altar covers and multi-part covers that overlap an opposing sidewall can be manufactured. A closure can be easily integrated into the hinged cover boxes by inserting magnets into recesses of the cardboards of mutually overlapping covers or the cover and the sidewall, respectively. At least the inner side of the single-element or multi-element and, if applicable, multi-piece cover is preferably lined with a cover material.

The joining of the multi-element box part to the third and fourth sidewalls can be easily realized in that the third and fourth sidewalls are initially glued on the inner side of the first sidewall with their first straps, and in that the second sidewall of the multi-element box part is subsequently folded and glued onto the second straps. Due to these measures, the inner side of the first sidewall is freely accessible for positioning the third and fourth sidewalls and for pressing on the first straps. If the bottom of the multi-element box part is already folded orthogonal to the first sidewall before the third and fourth sidewalls are glued onto the inner side of the first sidewall, the third and fourth sidewalls can be aligned relative to the bottom that extends orthogonal to the first sidewall prior to the joining process.

Recessed grips or similar openings in the outer edges of the sidewalls can be realized with contours other than a straight line in the outer edges of the first and/or second sidewall. Since the first and second sidewalls form parts of the multi-element box part, thusly curved edges can already be turned in and pressed on in the cardboard lining and turn-in machine.

### BRIEF DESCRIPTION OF THE DRAWING

Aspects of the present invention are elucidated in the following description with reference to the attached drawing, in which FIGS. 1 to 5 show different embodiments of an inventive box, and wherein

FIG. 1 shows a book slipcase with recessed grips;

FIG. 2 shows a hinged cover box with a simple cover;

FIG. 3 shows a hinged cover box with an altar cover;

FIG. 4 shows a hinged cover box with mutually overlapping covers, and

FIG. 5 shows a hinged cover box with a cover that overlaps the opposing sidewall.

FIGS. 6 to 8 listed below show the steps of the inventive method, wherein

FIG. 6 shows a block diagram of the process steps;

FIG. 7 schematically shows the joining of a multi-element box part to third and fourth sidewalls, and

FIG. 8 shows a detail of a grooved folding line.

### DETAILED DESCRIPTION

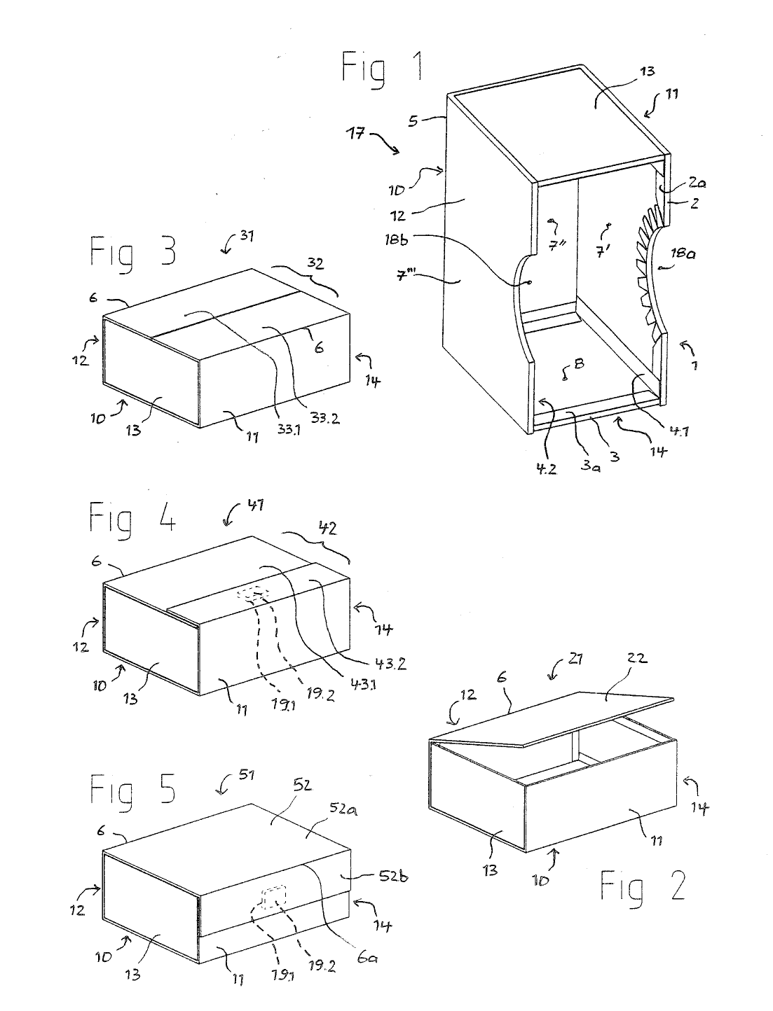

The book slipcase 17 in FIG. 1 comprises a case that is essentially closed on five sides and composed of (a) a multi-element box part 1 that features a bottom 10 and first and second sidewalls 11, 12, and (b) third and fourth sidewalls 13, 14. The multi-element box part 1 features cardboards 7′, 7″, 7′″ that are arranged parallel to one another and jointly lined with a cover material 2 over the entire surface and with turn-ins 2a on all sides. It is orthogonally folded twice about folding lines 5. The third and fourth sidewalls 13, 14 that respectively feature a cardboard 8 lined with a cover material 3 over its entire surface are connected to the box part 1 by means of first and second straps 4.1, 4.2 glued onto the inner side of the first and second sidewalls 11, 12 in order to form a rigid book slipcase 17. Recessed grips 18a, b are realized on the outer edges of the first and second sidewalls 11, 12 in the form of recesses in the cardboards 7′ and 7′″, wherein cover material 2 punched out in a notched fashion is turned in on these recessed handles.

The hinged cover box 21 according to FIG. 2 is closed on five sides and features a cover 22 that is arranged on a second sidewall 12 by means of a hinge 6. The cover 22 forms a component of the multi-element box part.

The hinged cover box 31 according to FIG. 3 features a multi-piece altar cover 32 with first and second altar covers 33.1, 33.2 that are respectively arranged on the opposing first and second sidewalls 11 and 12 by means of a hinge 6 and abut one another when the altar cover 32 is closed. Both altar covers 33.1, 33.2 also form components of the multi-element box part in this case.

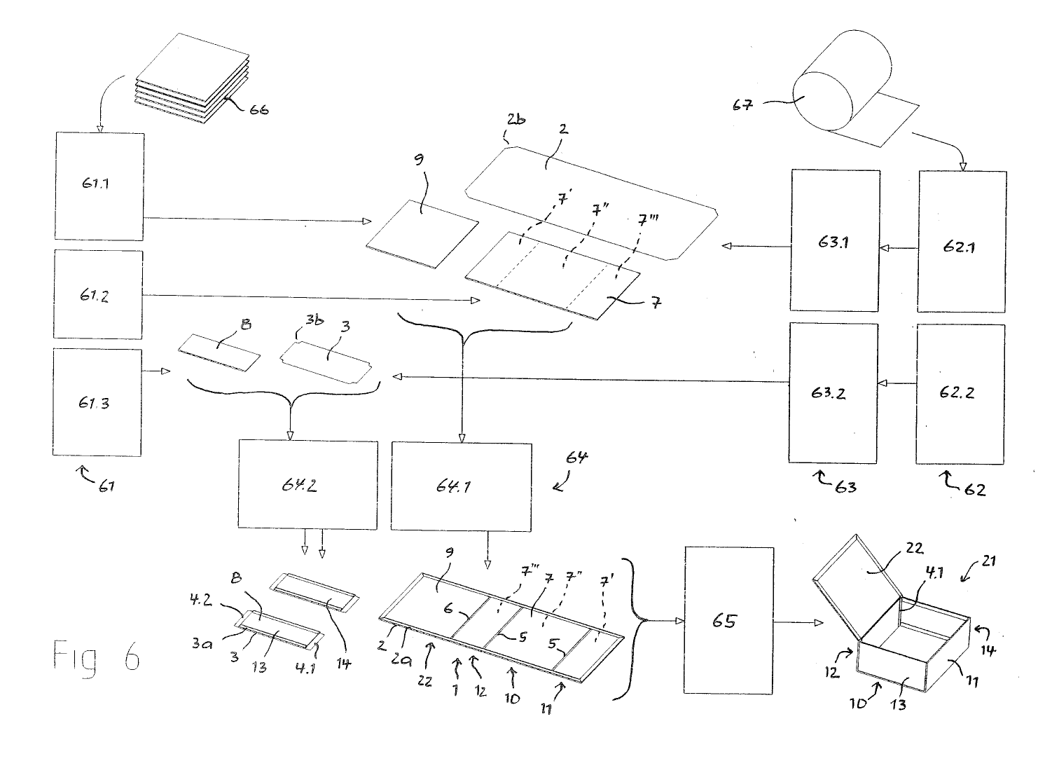

The hinged cover box 41 according to FIG. 4 analogously features a multi-piece cover 42, wherein the first and second cover 43.1, 43.2 mutually overlap. A magnetic closure is provided on the covers 43.1, 43.2 in that magnets 19.1, 19.2 are inserted into recesses of the cardboards in the region, in which the covers 43.1, 43.2 mutually overlap.

The hinged cover box 51 according to FIG. 5 features a multi-element cover 52 that is arranged on the second sidewall 12. The cover 52 features first and second cover parts 52a, b that are connected to one another in an articulated fashion by an additional hinge 6a. When the cover 52 is closed, the second cover part 52b overlaps the opposing first sidewall 11. A magnetic closure with magnets 19.1, 19.2 recessed into the first sidewall 11 and into the cover part 52b is also provided in this case.

The above-described embodiments of the inventive box merely represent a small selection of possible box constructions. Other rigid boxes such as standing slipcases, slip-top boxes (with two cases realized in accordance with the inventive construction principle), etc., may also be constructed in accordance with the inventive construction principle—multi-element box part 1 and separate sidewalls 13, 14 glued thereto.

An embodiment of the inventive method for manufacturing such boxes is illustrated in the form of a block diagram in FIG. 6, with reference to the example of a hinged cover box 21 with a simple cover 22. During the manufacture, cardboards 7, (7′, 7″, 7′″), 8, 9 and cover blanks 2, 3 cut to the respective format are processed. For reasons of completeness, the steps of cutting the materials to size are also illustrated.

The required cardboards 7, (7′, 7″, 7′″), 8, and cover cardboard 9 are cut out of large-format cardboard sheets 66. The cardboards are cut to size 61 by means of circular cardboard shears. Several passes 61.1 to 61.3 are required for producing the different cardboards 7, (7′, 7″, 7′″), 8, 9 of a box 21. The required cover blanks 2, 3 are cut with blank cutting machines. The cover material may be supplied in the form of rolls 67 or sheets. It may consist of simple paper, printed paper, sheet-lined paper, film, fabric, leather, etc. The blank cutting process 62 is followed by the corner removal 63, in which unneeded cover material is removed in the region of the subsequent turn-ins 2a, 3a. On the cover blank 2 for the multi-element box part 1, the corners 2b are removed straight while the corners 3b of the cover blank 3 for the third and fourth sidewalls 13 and 14 is removed in a notched fashion. Two passes 62.1, 62.2 and 63.1, 63.2 are respectively required because two different cover blanks 2, 3 are needed.

The correspondingly cut individual parts of the multi-element box part 1, as well as the third and fourth sidewalls 13, 14, are then joined in separate passes 64.1, 64.2 by means of a cardboard lining and turn-in machine such as, e.g., a casemaker. The cardboard lining process 64 includes turning in the protruding cover blank edges, wherein at least two opposing edges of the cover material 3 in the form of first and second straps 4.1, 4.2 are not turned in on the third and fourth sidewalls 13, 14.

The cardboard lining process 64 may be followed by finishing steps such as embossing or attaching closures, etc. For example, magnets 19.1, 19.2 may be inserted into corresponding recesses of the cardboards. At least the inner side of the subsequent cover 22 may be lined with a cover material 20 in an additional lining process.

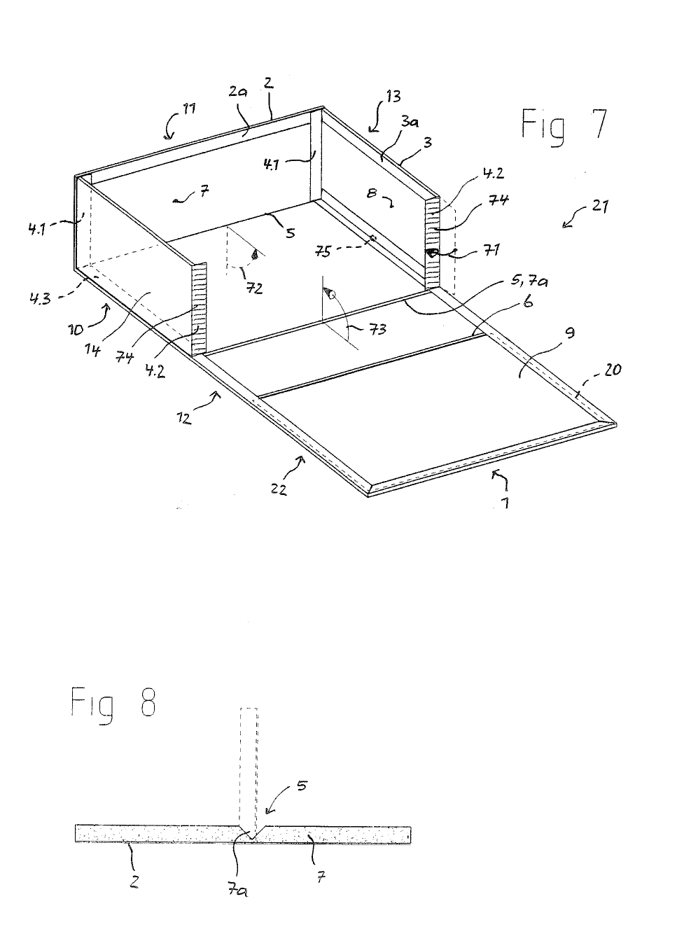

According to FIG. 6, the individual cardboards 7, (7′, 7″, 7′″), 9 are adjacently arranged parallel to one another in the multi-element box part 1. The folding lines 5 and the hinges 6 are realized between the spaced-apart cardboards 7, (7′, 7″, 7′″), 9. In the hinged cover box 21 with a simple cover 22, four individual cardboards are required, namely one respective cardboard 7′, 7″, 7′″ for the bottom 10 and the first and second sidewalls 11, 12, as well as one cardboard 9 for the cover 22. The cardboards 7′, 7″, 7′″ may also be supplied in the form of a one-piece cardboard 7 in order to realize edges that are particularly sharp and completely filled out on the hinged cover box 21, wherein the folding lines 5 are realized in the one-piece cardboard 7 in the form of V-shaped grooves 7a. In this context, see also FIG. 8. The grooves may be produced directly before lining of the one-piece cardboard 7 in the casemaker.

At the end of the manufacturing method, joining 65 of the hinged cover box 21 is carried out as described below with reference to FIG. 7. The two straps 4.1, 4.2 of the third and fourth sidewalls 13, 14 are orthogonally folded inward (fold 71) and provided with a glue layer 74. The first straps 4.1 of the third and fourth sidewalls 13, 14 are then glued onto the inner side of the first sidewall 11 of the multi-element box part 1. Subsequently, the multi-element box part 1 is twice folded 72 and 73 about the third and fourth sidewalls 13, 14 such that the second sidewall 12 of the multi-element box part 1 ultimately is pressed on the second straps 4.2 of the third and fourth sidewalls 13, 14 and glued thereto.

Prior to gluing on the first straps 4.1, the bottom 10 of the multi-element box part 1 may already be folded orthogonal to the first sidewall 11 such that the third and fourth sidewalls 13, 14 can be aligned relative to the bottom 10.

The third and fourth sidewalls 13, 14 may be joined flush with or slightly set back to the outer edges of the first and second sidewalls 11, 12. In boxes with a relatively wide bottom 10 (large distance between the first and second sidewalls 11, 12), the stability can be improved by respectively gluing an edge of the third and fourth sidewalls 13, 14 that faces the bottom 10 to the bottom 10 in one or several additional gluing points 75. Alternatively, a third strap 4.3 that is not turned in can be glued to the inner side of the bottom 10 on the corresponding edge of the third and fourth sidewalls 13, 14.

1. A method for mechanically manufacturing a rigid box (17, 21, 31, 41, 51), comprising:
forming a multi-element box part (1) with a bottom (10) and at least first and second sidewalls (11, 12) by joining cardboards (7, 7′, 7″, 7′″, 9) arranged parallel to one another to define a unitary flat composite board having an inside surface and an outside surface, with a cover material (2) that covers the entire outside surface and has turn-ins (2a) around the entire outside surface onto the inside surface;
forming separate third and fourth sidewalls (13, 14), each with a cardboard (8) having an inside surface and an outside surface, and a cover material (3) that covers the entire outside surface with at least two opposing edges of the cover material (3) protruding from the outside surface in the form of at least first and second straps (4.1, 4.2) while at least one other edge of the cover material is folded over as a turn-in onto the inside surface (3a); and
connecting the multi-element box part (1) to the third and fourth sidewalls (13, 14) by orthogonally folding the first and second straps (4.1, 4.2) relative to the respective surfaces of the third and fourth sidewalls and gluing the straps onto the first and second sidewalls (11, 12).

2. The method according to claim 1, including gluing one of said other edges of each of the third and fourth sidewalls (13, 14) to the bottom (10).

3. The method according to claim 2, wherein each of the third and fourth sidewalls has a respective third strap and the method includes orthogonally folding each third strap relative to the respective surfaces of the third and fourth sidewalls and gluing the third straps to the inside of the bottom (10).

4. The method according to claim 1, wherein during the joining of the multi-element box part (1), the folding lines (5) between the bottom (10) and the first and second sidewalls (11, 12) are grooved prior to the lining with the cover material (2).

5. The method according to claim 3, wherein during the joining of the multi-element box part (1), the folding lines (5) between the bottom (10) and the first and second sidewalls (11, 12) are grooved prior to the lining with the cover material (2).

6. The method according to claim 1, wherein the multi-element box part (1) comprises at least one additional cardboard (9) forming a single-element or multi-element and, if applicable, multi-piece cover (22, 32, 42, 52), said at least one additional cardboard (9) being arranged parallel to the cardboards (7, 7′, 7″, 7′″) forming the bottom (10) and the sidewalls (11, 12) and is lined jointly with said cardboards such that the cover (22, 32, 42, 52) is connected to the first and/or second sidewall (11, 12) in an articulated fashion.

7. The method according to claim 6, further including inserting magnets (19.1, 19.2) into recesses of the cardboards of mutually overlapping covers (42 with 43.1, 43.2) or the cover (52 with 52b) and the sidewall (12), respectively.

8. The method according to claim 6, wherein at least the inner side of the single-element or multi-element and, if applicable, multi-piece cover (22, 32, 42, 52) is lined with a cover material (20).

9. The method according to claim 1, wherein when joining the multi-element box part (1) to the third and fourth sidewalls (13, 14), the third and fourth sidewalls (13, 14) are initially glued onto the inner side of the first sidewall (11) with their first straps (4.1) and the second sidewall (12) of the multi-element box part (1) is subsequently folded and glued onto the second straps (4.2).

10. The method according to claim 9, wherein the bottom (10) of the multi-element box part (1) is folded orthogonal to the first sidewall (11) prior to gluing the third and fourth sidewalls (13, 14) onto the inner side of the first sidewall (11).

11. A box, comprising:
a multi-element box part (1) with a bottom (10) and at least first and second sidewalls (11, 12), formed by cardboards (7, 7′, 7″, 7′″) that are arranged parallel to one another to define a unitary flat composite board having an inside surface and an outer surface with a common cover material (2) that covers the entire outside surface and with turn-ins around the inner surfaces; and
separate third and fourth sidewalls (13, 14) that respectively consist of a cardboard (8) having an inside surface and an outside surface with a cover material (3) that covers the entire outside surface with at least two opposing edges of the cover material (3) protruding from the outside surface in the form of at least first and second straps (4.1, 4.2) while at least one other edge of the cover material is folded over aa a turn-in onto the inner surface (3a);
wherein the first and second straps (4.1, 4.2) are glued onto the inner side of the first and second sidewalls (11, 12), thereby connecting the third and fourth sidewalls to the multi-element box part (1) to form a rigid box (17, 21, 31, 41, 51) that is closed on at least five sides.

12. The box according to claim 11, wherein an edge of the third and fourth sidewalls (13, 14) that respectively faces the bottom (10) is glued onto the bottom (10) at least in certain points.

13. The box according to claim 11, wherein the multi-element box part (1) features at least one one-piece cardboard (7), wherein the folding lines (5) between the bottom (10) and the first and second sidewalls (11, 12) are grooved.

14. The box according to claim 12, wherein the multi-element box part (1) features at least one one-piece cardboard (7), wherein the folding lines (5) between the bottom (10) and the first and second sidewalls (11, 12) are grooved.

15. The box according to claim 11, wherein the multi-element box part (1) comprises at least one additional cardboard (9) lining a single-element or multi-element and, if applicable, multi-piece cover (22, 32, 42, 52), said at least one additional cardboard (9) being arranged parallel to the cardboards (7, 7′, 7″, 7′″) forming the bottom (10) and the sidewalls (11, 12) and is lined jointly with said cardboards such that the cover (22, 32, 42, 52) is connected to the first and/or second sidewall (11, 12) in an articulated fashion.

16. The box according to claim 15, further including magnets (19.1, 19.2) inserted into recesses of the cardboards of mutually overlapping covers (42 with 43.1, 43.2) or the cover (52 with 52b) and the sidewall (12), respectively.

17. The box according to claim 11, wherein at least the inner side of the single-element or multi-element and, if applicable, multi-piece cover (22, 32, 42, 52) is lined with a cover material (20).

18. The box according to claim 12, wherein at least the inner side of the single-element or multi-element and, if applicable, multi-piece cover (22, 32, 42, 52) is lined with a cover material (20).

19. The box according to claim 11, wherein the outer edge of the first and/or second sidewall (11, 12) that faces the bottom (10) has a contour other than a straight line.

20. The box according to claim 12, wherein the outer edge of the first and/or second sidewall (11, 12) that faces the bottom (10) has a contour other than a straight line.
